(19) United States
(12) Patent Application Publication
(10) Pub. No.: US 2025/0173154 A1
(43) Pub. Date: May 29, 2025

(54) AUTOMATED OPERATING SYSTEM (OS) INSTALLER PRE-BOOTING

(71) Applicant: Red Hat, Inc., Raleigh, NC (US)

(72) Inventor: Lukas Zapletal, Brno (CZ)

(21) Appl. No.: 18/520,296

(22) Filed: Nov. 27, 2023

(51) Int. Cl. G06F 9/4401; G06F 8/61

(52) U.S. Cl. CPC G06F 9/4406; G06F 8/61

(57) ABSTRACT

Techniques for booting a computing device are disclosed. An example method includes, in response to powering on or rebooting a computing device, performing a pre-boot process comprising loading an Operating System (OS) installer into storage of the computing device and executing the OS installer. The method also includes entering, by a processing device executing the OS installer, a standby state after performing the pre-boot process. The method also includes in response to receiving an activation instruction, exiting the standby state and installing an operating system of the computing device.

### TECHNICAL FIELD

Aspects of the present disclosure relate to bootable computing devices, and more particularly, to techniques for performing a pre-boot process for computing devices.

### BACKGROUND

Booting is process used to start various types of computing devices, including personal computers, laptops, servers, network equipment, storage appliances, and others. The boot process may include a variety of processes and initialization routines, which may include hardware tests, installation and configuration of software such as operating systems and drivers, among others. For some computing devices, the boot process may take several minutes.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of an example system for pre-booting hardware, in accordance with some embodiments of the present disclosure.

FIG. 2 is a diagram depicting an example boot process, in accordance with some embodiments of the present disclosure.

FIG. 3 is a diagram depicting a method of booting a plurality of computing devices, in accordance with some embodiments of the present disclosure.

FIG. 4 is a process flow diagram summarizing a method of booting a computing device, in accordance with some embodiments of the present disclosure.

FIG. 5 is a simplified block diagram of an example system for booting a computing device, in accordance with some embodiments of the present disclosure.

FIG. 6 illustrates a diagrammatic representation of a machine in the example form of a computer system within which a set of instructions, for causing the machine to perform any one or more of the methodologies discussed herein, may be executed.

### DETAILED DESCRIPTION

Aspects of the present disclosure relate to techniques performing a pre-boot process for computing devices. When a computing device such as a Personal Computer (PC) or server is turned on, it performs a series of initialization routines, such as Basic Input/Output System (BIOS) checks, hardware tests, and Extensible Firmware Interface (EFI) or unified EFI (UEFI) validations or boot sequences. For some computing devices such as network and disc array appliances, this process can take up to dozens of minutes.

After the initialization routines, an Operating System (OS) may be loaded for many types of hardware, including but not limited to servers, PCs (e.g., desktops, laptops), mobile devices (smart phones), and the like. In some cases, the operating system may already be installed, in which case the operating system is loaded from storage into main memory and instructions of the operating system are executed. If an operating system has not already been installed or if the computing device is being re-provisioned to include a new operating system, an OS installation process is performed.

The installation of the operating system may be performed by an OS installer that controls the installation process by setting up basic configuration information such as disk drive partitioning, package and package group selection, location, time zone, user accounts, passwords, network configuration, and additional software configurations. When the computing device is turned on, the OS installer is loaded into memory from a removable device (e.g., USB flash memory, HDD/SSD drive, eMMC memory, CD-ROM, DVD-ROM) or from a network. The configuration information needed to complete the installation may be obtained differently depending on whether the installation is attended or unattended. In attended installation, the OS installer presents a series of questions to a user through a user interface such as a command line interface to obtain the configuration information. In unattended installation, the OS installer obtains a predefined configuration file that contains all the configuration information, thereby eliminating the need for user interaction during the installation process. Unattended installation may be useful for mass-installation of operating systems for several computing devices to save human labor and ensure consistency between computing devices. After receipt and/or confirmation of the configuration information, the OS installation is performed and the computing device is then restarted into an operational mode or powered off. As can be appreciated from the above description, the process for booting and provisioning hardware can be a very time-consuming process. This is especially true in a data center when large numbers of computing devices are being re-provisioned or provisioned for the first time.

Embodiments of the present techniques describe an improved process for booting computing devices. Specifically, the present disclosure describes techniques for pre-booting a computing device into a standby state. To initiate the pre-boot process, the computing device may be powered on or rebooted either by a user or by a software component referred to herein as a boot orchestrator. During the pre-boot process, the initialization routines (e.g., BIOS checks and hardware tests) are performed and the OS installer is loaded into memory. The computing device then enters the standby state, during which it waits for a command to resume the boot process. Thus, the computing device boots into the OS installer before OS installation is requested.

During the standby state, the OS installer enters a waiting loop and waits for a command from the boot orchestrator to continue with the OS installation. When a user or other computer system requests OS installation, the boot orchestrator returns an installation configuration to the computing device and the OS installation process begins and continues normally. According to the embodiments disclosed herein, the process for booting a computing device can be completed more quickly from the standpoint of the user because the initialization procedures and downloading of the OS installer will have already been completed by the time the boot request is received at the computing device. This enables hardware to be provisioned more quickly, resulting in significant time savings for system administrators and reduced lag time for data center customers.

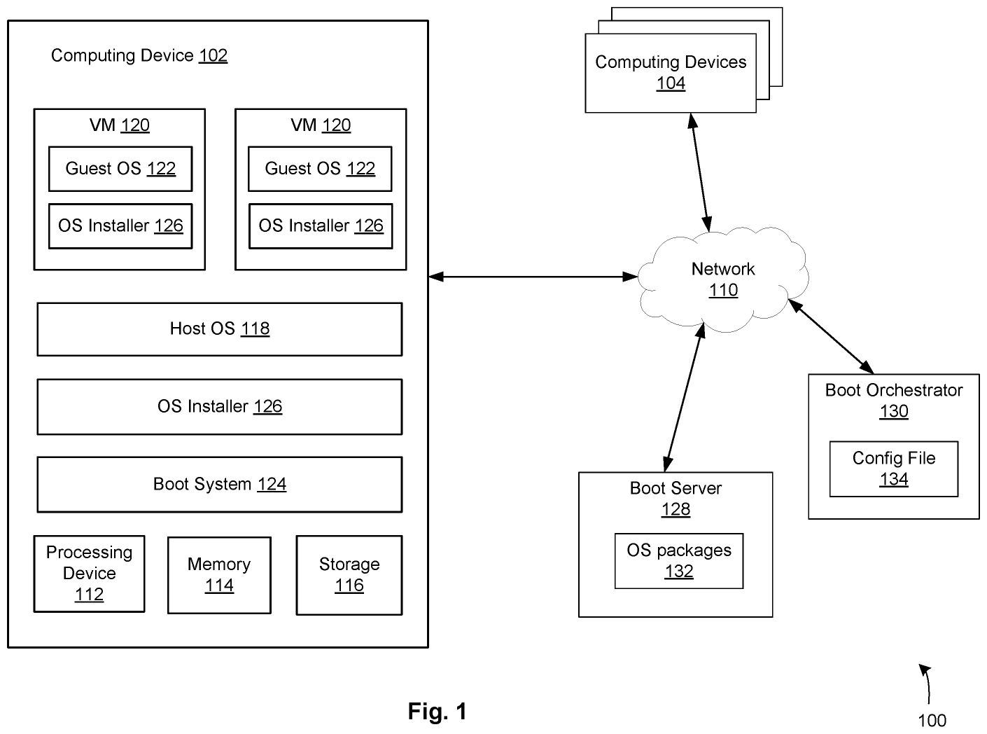

FIG. 1 is a block diagram of an example system 100 for pre-booting hardware, in accordance with some embodiments of the present disclosure. One skilled in the art will appreciate that other architectures are possible for system 100 and that the implementation of the system is not necessarily limited to the specific architecture depicted by FIG. 1.

The system 100 includes computing device 102, computing devices 104, a boot server 106, and a boot orchestrator 108, which may be communicatively coupled to each other via a network 110. The network 110 may be a public network (e.g., the internet), a private network (e.g., a local area network (LAN) or wide area network (WAN)), or a combination thereof. In one embodiment, the network 110 may include a wired or a wireless infrastructure, which may be provided by one or more wireless communications systems, such as a WiFi™ hotspot connected with the network 110 and/or a wireless carrier system that can be implemented using various data processing equipment, communication towers (e.g., cell towers), etc. In some embodiments, the network 110 may be an L3 network. The network 110 may carry communications (e.g., data, message, packets, frames, etc.) between the computing device 102, computing devices 104, boot server 106, and boot orchestrator 108.

The computing system 102 can include one or more processing devices 112 (e.g., central processing units (CPUs), graphical processing units (GPUs), etc.), main memory 114, which may include volatile memory devices (e.g., random access memory (RAM)), non-volatile memory devices (e.g., flash memory) and/or other types of memory devices, and a storage device 116 (e.g., one or more magnetic hard disk drives, a Peripheral Component Interconnect (PCI) solid state drive, a Redundant Array of Independent Disks (RAID) system, a network attached storage (NAS) array, etc.). In certain implementations, main memory 114 may be non-uniform access (NUMA), such that memory access time depends on the memory location relative to processing device 112. The storage device 116 may be a persistent storage and may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The storage device 116 may be configured for long-term storage of data. It should be noted that although, for simplicity, a single processing device 112, main memory 114, storage device 116, are shown, other embodiments may include a plurality of processing devices, memories, and storage devices. Additionally, the computing system 102 may have additional components not shown in FIG. 1. The computing devices 104 may include similar architectures.

The computing devices 102 and 104 may be any suitable type of computing devices, including servers, desktop computers, laptop computers, network appliances (e.g., switch, router), network attached storage (NAS) devices, etc. In some embodiments, the system 100 may be a cloud-based infrastructure, for example, Service as a Service (SaaS) or Platform as a Service (PaaS), and the computing device 102 and 104 may be a collection of multiple servers configured in a cluster.

The computing device 102 may include a host operating system 118 that manages the execution of other components (e.g., software, applications, etc.) of the computing device 102. The host operating system 118 may also manage access to and operation of the hardware (e.g., processors 112, memory 114, storage devices 116, etc.) of the computing device 102.

The computing device 102 may also include one or more virtual machines (VMs) 120. The VMs may execute on a hypervisor (not shown) which executes on top of the host operating system 118. The hypervisor may manage system sources (including access to hardware devices, such as processors, memories, storage devices). The hypervisor may also emulate the hardware (or other physical resources) which may be used by the VMs 120 to execute software applications. Each VM 120 may also include a guest operating system 122 that manages execution of the VMs applications and manages access to and operation of the hardware (e.g., processors 112, memory 114, storage devices 116, etc.) through the hypervisor.

The computing device 102 also includes a boot system 124, which may be a BIOS EFI, UEFI, or any other suitable type of boot system. The boot system 124 may be stored to a non-volatile memory component of the computing device such as a read-only memory (ROM), erasable programmable ROM (EPROM), flash memory, etc. When activated, the boot system 124 performs a variety of processes, including system initialization routines and the loading of an operating system. The boot system 124 may be activated in response to the power up or reboot of the computing device 102. As used herein, the term reboot may be used to refer to a soft reboot or a hard reboot. In a hard reboot, the power is cycled (i.e., turned off then on again) to temporarily discontinue power to the computing device's hardware. In a soft reboot (also sometimes referred to as a reset), the computing device 102 is caused to restart and reload its operating system without interrupting power to the computing device 102 and its hardware.

The initialization routines performed by the boot system 124 may include a series of hardware tests to verify CPU registers, verify the integrity of the BIOS code, verify the integrity of the main memory (e.g., memory 114), and others. This process for testing and initializing the computer system's components takes place during a pre-boot sequence sometimes referred to as a power-on self-test (POST). After the initialization routines are completed, the boot system 124 can load an OS installer 126, which loads the host operating system 118 into non-volatile memory (e.g., storage 116.) The OS installer 126 may be obtained from a local storage device (e.g., storage 116) such as the storage, an optical disc drive, as USB flash drive, etc. In some embodiments, the OS installer 126 is retrieved from a boot server 128 over the network 110. The boot server 128 may be a server that includes the OS installer 126 and one or more operating system packages 132 that the OS installer 126 can download to the computing device 102 to become the computing device's host operating system 186. In a similar manner, each of the VMs 120 may also obtain and/or load an instance of the OS installer 126 to load the VM's respective guest operating system 122 when the particular VM 120 is instantiated.

The system 100 may also include a boot orchestrator 130 that communicates with the OS installer 126 to control the boot process. In some embodiments, the boot orchestrator 130 includes an OS configuration file 134 that can be used for unattended OS installation. The OS configuration file 134 may include a variety of settings used to configure the operating system for the particular computing device 102 or 104 or VM 120. For example, the configuration file 134 may include an OS package identifier or package group identifier that identifies a particular OS package 132 to be loaded, disk drive partitioning information, location and/or time zone information, user accounts and passwords, network configuration information, and others.

Once the OS installer 126 has been loaded, the OS installer 126 can enter a standby state wherein it waits for a command from the boot orchestrator 130 before it proceeds to upload the configuration file 134 and/or operating system package 132 and proceed with the rest of the boot process. During the standby state, the OS installer 126 may periodically communicate with the boot orchestrator 130 in regular intervals to request that the boot process continue (pull method). In some embodiments, the OS installer 126 may remain inactive and wait for instructions from the boot orchestrator 130 regarding whether to continue the boot process (push method). Communication between the OS installer 126 and the boot orchestrator 130 may use any suitable communication protocol, including Transmission Control Protocol (TCP), User Datagram Protocol (UDP), Internet Control Message Protocol (ICMP) or application protocol including but not limited to Hypertext Transfer Protocol (HTTP), Hypertext Transfer Protocol Secure (HTTPS), or QUIC.

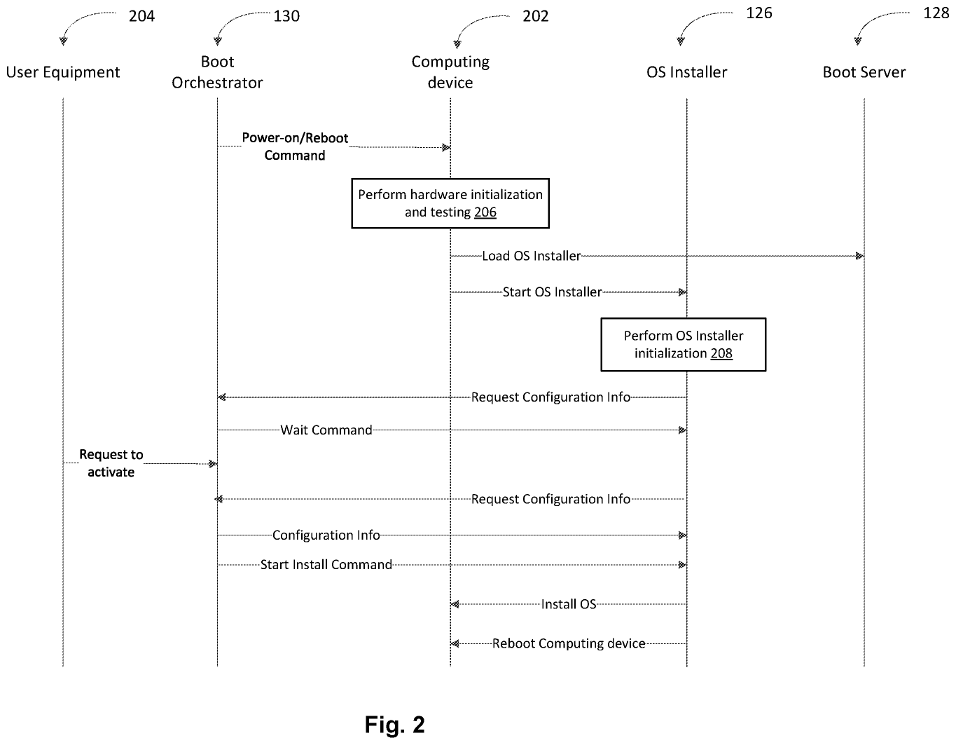

When a user or other computer system requests activation of the computing device 102, the boot orchestrator 130 returns an installation configuration and the OS installation process begins. In the case of unattended OS installation, the installation configuration may be returned in the form of a configuration file 134. In other embodiments, the installation configuration may be returned manually by the user in response to user prompts generated by the OS installer 126. The request to perform OS installation may be received from a computing device over a network in the form of a web request, a remote procedure request (e.g., gRPC), a UDP packet, as an application programming interface (API) call (e.g., HTTP REST API), and others. Additionally, the request to perform OS installation may be triggered by user selection or by software executing an automated process for provisioning computing resources. It will be appreciated that when the user requests OS installation, the user may not be aware that the computing device 102 has already been powered on and pre-booted. Thus, from the user perspective, the user may be requesting that the computing device power on. Since the computing device is already powered and has completed portions of the boot sequence, the user will perceive that the entire boot process was accomplished more quickly. A process for pre-booting a computing device is described further in relation to FIG. 2.

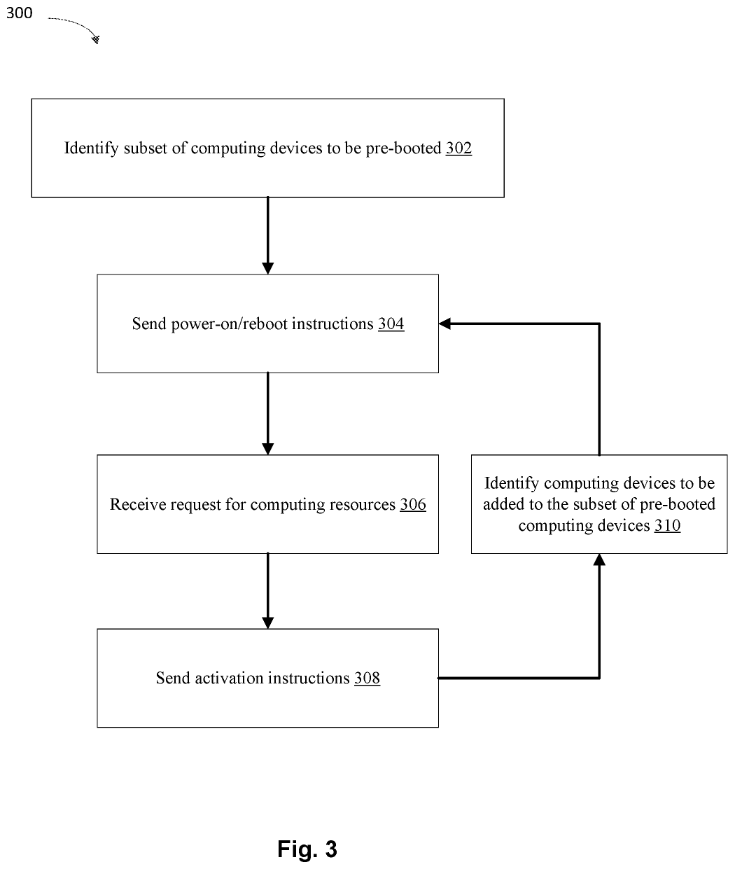

In some embodiments, the boot orchestrator 130 may also be the component that requests the computing device 102 to power on or reboot into the standby state. For example, the boot orchestrator 130 may function to maintain one or more computing systems on standby, i.e., in the pre-booted standby state, until additional computing resources are needed or requested. When computing resources are requested to boot up, the boot orchestrator 130 may instruct a pre-booted computing system (e.g., computing system 102) to exit the standby state, continue with the operating system installation, and finish the boot process, while instructing another computing device (one of computing devices 104) to power on and proceed to the standby state. In this way, power can be conserved by keeping some computing devices powered down without losing the improved boot-up speed provided by the present techniques. A process for coordinating the booting of a system of computing devices is described further in relation to FIG. 3.

It will be appreciated that embodiments of the system 100 may include additional components not shown in FIG. 1 and that some of the components shown in FIG. 1 may be omitted or combined according to the architectural specification suitable for a particular implementation. For example, boot orchestrator 130 and the boot server 128 may be included in a same server coupled to the network 110.

FIG. 2 is a diagram depicting an example boot process, in accordance with some embodiments of the present disclosure. With reference to FIG. 1, the boot process 200 may be performed to boot up the computing device 102, the computing devices 104, the VMs 120, or any other bootable computing hardware or virtual device that loads an operating system. In FIG. 2, the boot process 200 is performed to boot up the computing device 202, which may be the computing device 102, one of the computing devices 104, or one of the VMs 120, or other bootable device. The boot process 200 may also involve operations performed by the boot orchestrator 130, the OS installer 126, the boot server 128, and user equipment 204.

The boot process 200 starts when the computing device 202 is powered on or rebooted. As shown in FIG. 2, the computing device 202 may be powered on or rebooted by a command received from the boot orchestrator 130. In other embodiments, the computing device 202 may be powered on or rebooted by a command received from another component such as the user equipment 204, or through the computing device itself, e.g., pressing a button, plugging the computing device into a power source, etc.

Next, at block 206, the computing device 202 performs hardware initialization and testing. Hardware initializing and testing may include power-on-self-test (POST) processes, memory training, PCIe link training, USB link training, and others.

The computing device 202 then loads the OS installer 126 by sending a request for the OS installer 126 to the boot server 128. It will be appreciated that in other embodiments, the OS installer 126 may be received from another boot source, including an optical disk inserted into an optical disk drive of the computing device 202 or a USB drive inserted into a USB port of the computing device 202. Other embodiments are also possible. The OS installer 126 may include the software and other data used to install an operating system on the computing device 102. In some embodiments, the OS installer 126 may include one or more operating system packages, each operating system package corresponding with a different type of operating system. The particular operating system to be installed may be specified by the configuration information to be received from the user and/or the boot orchestrator 130. The OS installer 126 may be loaded into a persistent storage device (e.g., storage 116 of computing device 102).

Once the OS installer 126 is downloaded, the computing device 202 starts the execution of the OS installer 126. At block 208, the OS installer 126 performs OS installer initialization. During the OS installer installation, the OS installer 126 prepares its environment to perform work for the installation. The OS installer initialization process may include system and storage initialization, including the verification of system requirements, creation of system component address spaces, and others.

After the OS installer 126 is initialized, the OS installer 126 requests OS configuration information from the boot orchestrator 130. If the computing device 202 has not been requested to become operable, the boot orchestrator 130 may send a wait command to the OS installer 126. The wait command may cause the OS installer 126 to pause execution and enter a standby state. While in the standby state, the OS installer 126 may periodically send a request for configuration information according to a pre-specified schedule or time increment, e.g., every second, five seconds, thirty seconds, etc. In other embodiments, the OS installer 126 sends a single request for configuration information and waits for a response without periodically resending new requests.

Next, a request to activate the computing device 202 is received by the boot orchestrator 130 from the user equipment 204. The user equipment 204 may be any suitable type of computing device. In some embodiments, the user equipment 204 may be coupled to a control plane of a clustered computing system and the request to activate the computing device 202 may be received from the user equipment 204 through the control plane. In some embodiments, the user equipment 204 may include software for automatically provisioning hardware based, for example, on workload requirements. In such embodiments, the request to activate the computing device 202 may be received from the automated provisioning software. From the perspective of the user or the process (e.g., provisioning software) requesting activation of the computing device 202, the request to activate the computing device 202 may be understood to be (and/or configured or formatted as) a request to power up or reboot the computing device 202. In other words, the user or the provisioning software may not have any awareness or information about the computing device's state and may assume or proceed as if the computing device 102 is powered down, for example.

Upon receiving a request for configuration information after receiving the request to activate the computing device 202, the boot orchestrator 130 then sends the configuration file 134 to the computing device 202. The boot orchestrator 130 may also send a command to the OS installer 126 to start installing the operating system on the computing device 202.

Next, the OS installer 126 installs the operating system on the computing device 202 in accordance with the configuration information in the configuration file 134. In some embodiments, the configuration file 134 may identify a specific operating system package, which determines the type of operating system to be installed. Installing the operating system includes storing the operating system files to a persistent, i.e., non-volatile, storage device (e.g., storage 116 of computing device 102). Installing the operating system may also include storing configuration settings for the operating system (e.g., Windows registry). Once the operating system is installed, the computing device 202 may be rebooted, i.e., restarted. Once the computing device 202 powers back on, the computing device 202 loads the installed operating system into the working memory and is ready to be used for its specified purpose (e.g., processing workloads, handling network traffic, storing data, etc.).

It can be appreciated that the boot process 200 may include additional processes not depicted and that some of the process depicted may be omitted depending on the design details of a specific embodiment.

FIG. 3 is a diagram depicting a method of booting a plurality of computing devices, in accordance with some embodiments of the present disclosure. The method 300 may be performed to boot up the computing device 102, the computing devices 104, the VMs 120, or any other bootable hardware or virtual device that loads an operating system. In some embodiments, the method 300 may be performed by the boot orchestrator 130 of FIG. 1. The method 300 may be performed to activate a group of computing devices while maintaining one or more pre-booted computing devices in a standby state. For example, the computing devices (e.g., compute nodes, storage nodes, servers, VMs) may be activated in response to changes in the processing or storage requirements of the system. The computing devices may also be a predetermined set of computing devices (e.g., servers) that are being brought online in stages. The method may begin at block 302.

At block 302, a subset of a computing devices to be pre-booted is identified. The subset of computing devices may be selected from a group of available computing resources and may include a single computing device or two or more computing devices of the group.

At block 304, power-on or reboot instructions are sent to the subset of computing devices. Each computing device may then perform the pre-boot process in response to being powered on or rebooted. The pre-boot process may be performed in accordance with the process described in reference to FIG. 2. For example, the pre-booted computing devices may perform hardware initialization and testing (block 204), load the OS installer 126, perform OS installer initialization (block 206), and enter the standby state.

At block 306, a request for computing resources is received. The request may be received from a user or from an automated provisioning software. For example, the request for computing resources may be triggered by automated provisioning software in response to an increased workload demands. Since the user and/or automated provisioning software may not be aware that the computing resources have already been powered on and pre-booted, the request sent by the user and/or automated provisioning software may be the same as a request to power on the requested computing resource. In some embodiments, the requests for computing resources is received by the boot orchestrator 130.

At block 308, activation instructions are sent to one or more of the pre-booted computing devices. The activation instructions may be sent by the boot orchestrator 130. The activation instructions may include configuration information (e.g., configuration file 134) and a command to start installing the operating system as described in reference to FIG. 2. Each activated computing device then exits the standby state and continues the boot process. Each activated computing device can then install the operating system in accordance with the configuration information and reboot, i.e., restart.

At block 310, one or more additional computing devices within the group of available resources is identified for addition to the subset of pre-booted computing devices. The number of computing devices to be pre-booted may be determined based on the number of computing devices activated at block 308 so that the number of pre-booted computing devices stays the same, provided the availability of additional computing devices. The process then returns to block 304 and power-on/reboot instructions are sent to the identified computing device or devices. In this way, a certain number of pre-booted computing devices is available in the standby state and can be quickly activated. While in the standby state, the pre-booted computing devices will consume a certain amount of electrical power. The process described in FIG. 3 allows computing devices to be quickly available when requested while also reducing the amount of electrical power consumed during the standby state since the available computing devices may not all be pre-booted at any given time.

It will be appreciated that embodiments of the method 300 may include additional blocks not shown in FIG. 3 and that some of the blocks shown in FIG. 3 may be omitted.

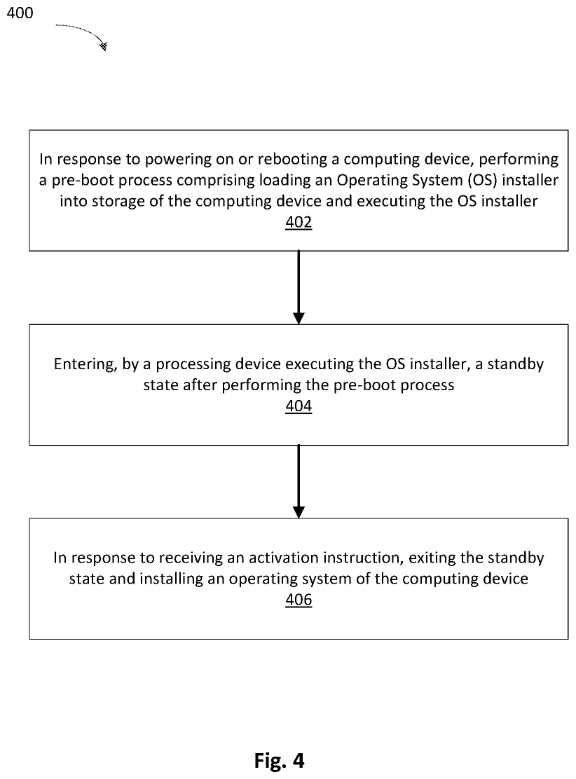

FIG. 4 is a process flow diagram summarizing a method of booting a computing device, in accordance with some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, aspects of the method 400 may be performed by the computing device 102, the computing devices 104, the VMs 120 of FIG. 1 or other bootable device. The method may begin at block 402.

At block 402, a pre-boot process is performed in response to powering on or rebooting a computing device. The computing device may power on or reboot in response to a power-on command or reboot (e.g., restart) command received from the boot orchestrator. The pre-boot process includes loading an Operating System (OS) installer into storage of the computing device and executing the OS installer. The pre-boot process may also include initializing and testing hardware of the computing device, e.g., power-on self-test (POST), initializing the OS installer, and other processes.

At block 404, the computing device enters a standby state after performing the pre-boot process. During the standby state, the OS installer waits until it receives some indication that the boot process is to be continued. In some embodiments, the receipt of the configuration information (e.g., configuration file) may be the indication that the boot process is to continue. In other embodiments, the boot process continues after receiving the configuration information and a start-install command.

During the standby state, OS configuration information for installing the operating system may be requested by the OS installer. For example, the OS configuration information may be requested periodically. In other embodiments, the OS configuration information is requested once. The request for OS configuration information may be sent to a boot orchestrator. The request for OS configuration information informs the boot orchestrator that the corresponding computing device has performed the pre-boot process and is prepared to be activated. The boot orchestrator may respond by sending the requested configuration information or a wait command back to the requesting computing device.

At block 406, the standby state is exited in response to receiving an activation instruction and an operating system of the computing device is installed. Receiving the activation instruction may include receiving a configuration file describing OS configuration information used by the OS installer to install the operating system. Receiving the activation instruction may also include receiving a command to start installing the operating system. The activation instruction may be received from the boot orchestrator, which sends the activation instruction to the computing device in response to a request for computing resources received from a user or through automated provisioning software, for example. In some embodiments, the boot orchestrator is configured to maintain one or more computing devices in the standby state while waiting to activate computing devices in response to resource requests. In attended installation, the configuration information and/or command to start installing the operating system may be received manually through an input device of the user equipment 204. For example, the user may physically insert new hardware into a rack, turn the hardware on, and walk to a workstation to complete the installation. When they arrive at the workstation, the corresponding systems may already be pre-booted and waiting for confirmation from the user to start the installation procedure.

It will be appreciated that embodiments of the method 400 may include additional blocks not shown in FIG. 4 and that some of the blocks shown in FIG. 4 may be omitted.

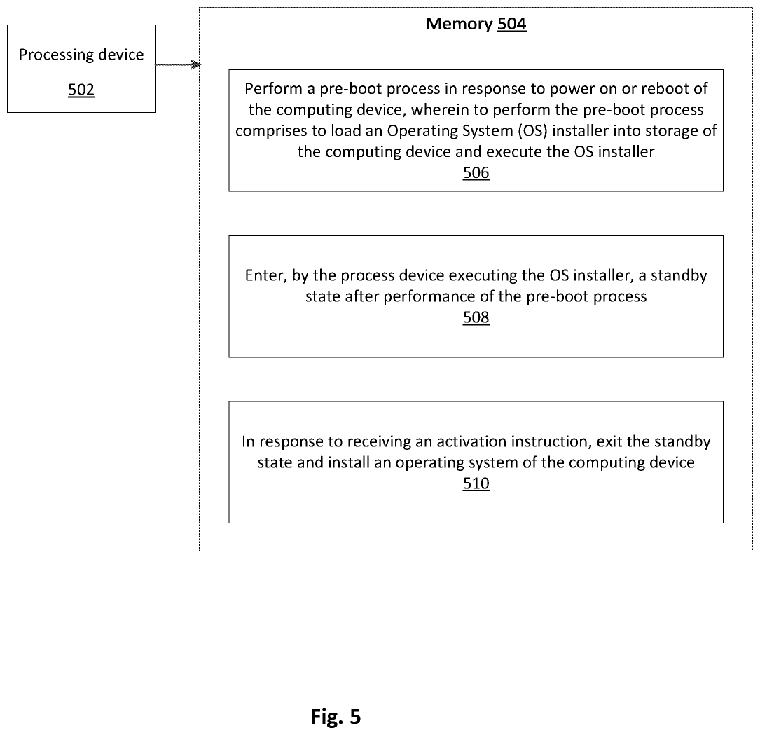

FIG. 5 is a simplified block diagram of an example system for booting a computing device, in accordance with some embodiments of the present disclosure. The system 500 includes a processing device 502 operatively coupled to a memory 504. The memory 504 can include instructions that are executable by the processing device 502 to cause the processing device 502 to perform a pre-boot process and then enter a standby state before installing an operating system.

The memory 504 includes instructions 506 to perform a pre-boot process in response to power on or reboot of a computing device, wherein to perform the pre-boot process comprises to load an Operating System (OS) installer into storage of the computing device and execute the OS installer. The memory 504 also includes instructions 508 to enter, by the process device executing the OS installer, a standby state after performance of the pre-boot process. The memory 504 also includes instructions 510, exit the standby state in response to receiving an activation instruction and install an operating system of the computing device. It will be appreciated that embodiments of the system 500 may include additional blocks not shown in FIG. 5 and that some of the blocks shown in FIG. 5 may be omitted.

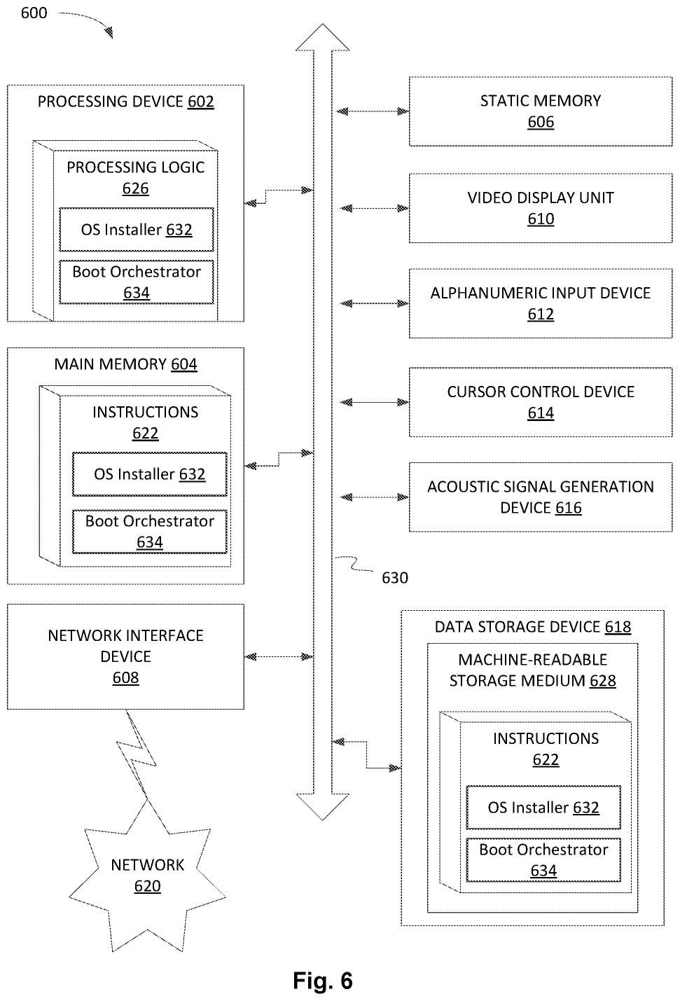

FIG. 6 illustrates a diagrammatic representation of a machine in the example form of a computer system 600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a web appliance, a server, and other machines capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 600 may be representative of a server, such as a cloud server, configured as a boot server and/or boot orchestrator.

The example computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute processing logic 626 for performing the operations and steps discussed herein. For example, the processing logic 626 may include logic for performing the functions of an OS installer 632 and/or a boot orchestrator 634.

The data storage device 618 may include a machine-readable storage medium 628, on which is stored one or more set of instructions 622 (e.g., software) embodying any one or more of the methodologies of functions described herein, including instructions to cause the processing device 602 to perform the functions of the OS installer 632 or the boot orchestrator 634. The instructions 622 may also reside, completely or at least partially, within the main memory 604 or within the processing device 602 during execution thereof by the computer system 600; the main memory 604 and the processing device 602 also constituting machine-readable storage media. The instructions 622 may further be transmitted or received over a network 620 via the network interface device 608.

While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “identifying,” “transmitting,” “sending,” “requesting,” “storing,” “determining,” “processing,” “generating,” “performing” “entering,” exiting,” “installing” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
in response to powering on or rebooting a computing device, performing a pre-boot process comprising loading an Operating System (OS) installer into storage of the computing device and executing the OS installer;
entering, by a processing device executing the OS installer, a standby state after performing the pre-boot process; and
in response to receiving an activation instruction, exiting the standby state and installing an operating system of the computing device.

2. The method of claim 1, wherein performing the pre-boot process comprises initializing and testing hardware of the computing device.

3. The method of claim 1, wherein performing the pre-boot process comprises initializing the OS installer.

4. The method of claim 1, comprising, during the standby state, requesting OS configuration information for installing the operating system.

5. The method of claim 1, wherein receiving the activation instruction comprises receiving a configuration file describing information used by the OS installer to install the operating system.

6. The method of claim 1, wherein the activation instruction is received from a boot orchestrator configured to maintain the computing device in the standby state while waiting to activate the computing device in response to a resource request.

7. The method of claim 6, wherein the computing device powers on or reboots in response to a power-on command or reboot command received from the boot orchestrator prior to receiving the resource request.

8. A computing device comprising:
a memory; and
a processing device, operatively coupled to the memory, the processing device to:
perform a pre-boot process in response to power on or reboot of the computing device, wherein to perform the pre-boot process comprises to load an Operating System (OS) installer into storage of the computing device and execute the OS installer;
enter, by the process device executing the OS installer, a standby state after performance of the pre-boot process; and
in response to receiving an activation instruction, exit the standby state and install an operating system of the computing device.

9. The computing device of claim 8, wherein to perform the pre-boot process comprises to initialize and test hardware of the computing device.

10. The computing device of claim 8, wherein to perform the pre-boot process comprises to initialize the OS installer.

11. The computing device of claim 8, wherein, during the standby state, the processing device is to request OS configuration information for installing the operating system.

12. The computing device of claim 8, wherein to receive the activation instruction comprises to receive a configuration file that describes information used by the OS installer to install the operating system.

13. The computing device of claim 8, wherein the activation instruction is received from a boot orchestrator configured to maintain the computing device in the standby state while waiting to activate the computing device in response to a resource request.

14. The computing device of claim 13, wherein the computing device powers on or reboots in response to a power-on command or reboot command received from the boot orchestrator prior to receiving the resource request.

15. A non-transitory computer-readable storage medium including instructions that, when executed by a processing device, cause the processing device to:
perform a pre-boot process in response to power on or reboot of a computing device, wherein to perform the pre-boot process comprises to load an Operating System (OS) installer into storage of the computing device and execute the OS installer;
enter, by the process device executing the OS installer, a standby state after performance of the pre-boot process; and
in response to receiving an activation instruction, exit the standby state and install an operating system of the computing device.

16. The non-transitory computer-readable storage medium of claim 15, wherein to perform the pre-boot process comprises to initialize and test hardware of the computing device.

17. The non-transitory computer-readable storage medium of claim 15, wherein to perform the pre-boot process comprises to initialize the OS installer.

18. The non-transitory computer-readable storage medium of claim 15, comprising instructions that cause the processing device to, during the standby state, request OS configuration information for installing the operating system.

19. The non-transitory computer-readable storage medium of claim 15, wherein to receive the activation instruction comprises to receive a configuration file that describes information used by the OS installer to install the operating system.

20. The non-transitory computer-readable storage medium of claim 15, wherein the computing device powers on or reboots in response to a power-on command or reboot command and wherein the activation instruction and the power-on command or reboot command are received from a boot orchestrator configured to power on or reboot the computing device and maintain the computing device in the standby state while waiting to activate the computing device in response to a resource request.
